(19) United States
(12) Patent Application Publication
(10) Pub. No.: US 2022/0114566 A1
(43) Pub. Date: Apr. 14, 2022

(54) SYSTEMS AND METHODS FOR USE IN FACILITATING MESSAGING

(71) Applicant: MASTERCARD INTERNATIONAL INCORPORATED, Purchase, NY (US)

(72) Inventors: Jason Jay Lacoss-Arnold, St. Louis, MO (US); Andrew David Lambert, Chesterfield, MO (US); Christy Hart, Wood Dale, IL (US)

(21) Appl. No.: 17/066,257

(22) Filed: Oct. 8, 2020

(51) Int. Cl. G06Q 20/10; H04L 12/58; G06Q 40/02; G06Q 20/02; G06Q 20/40; G06N 20/00

(52) U.S. Cl. CPC G06Q 20/108; H04L 51/046; G06Q 40/02; G06Q 20/367; G06Q 20/4016; G06Q 20/405; G06N 20/00; G06Q 20/023

(57) ABSTRACT

Systems and methods are provided for use in facilitating messages. An exemplary method includes receiving a first electronic message including an instruction from a first user and specific to a first user account, where the instruction is directed to a second user account of a second user, and transmitting a second electronic message including the instruction associated with the second user account. In response, the second user account is adjusted consistent with the instruction. The method also includes determining whether the instruction satisfies one or more parameters and then, in response to the instruction satisfying the one or more parameters, compiling and transmitting a third electronic message including a hold instruction, whereby the second user account is adjusted to include a hold feature consistent with the hold instruction.

### FIELD

The present disclosure generally relates to systems and methods for use in facilitating messaging (e.g., electronic messages, network messages, etc.).

### BACKGROUND

This section provides background information related to the present disclosure which is not necessarily prior art.

Entities are known to utilize network messages for various different purposes. Transferring funds is one such purpose, in which the messages indicate the transfer of funds from one account to another account. In one example, the network messages may indicate a transfer of funds in connection with a purchase of products or services by a user from a provider of such products or services. Also, the network messages may be provided through conventional payment networks, or they may be made through real time payment networks such as The Clearing House™ or Zelle™. Specifically, in the context of real time payment networks, The Clearing House™, for example, provides a platform to accommodate real time fund transfers for financial institutions integrated into the platform.

### DRAWINGS

The drawings described herein are for illustrative purposes only of selected embodiments and not all possible implementations, and are not intended to limit the scope of the present disclosure.

FIG. 1 is an exemplary system of the present disclosure suitable for use in facilitating messaging;

FIG. 2 is a block diagram of a computing device that may be used in the exemplary system of FIG. 1; and

FIG. 3 is an exemplary method that may be implemented in the system of FIG. 1 for use in facilitating messaging to place a hold on funds for an account in connection with a transaction by a user.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Network messaging is often defined according to a protocol or standard. For example, ISO 20022 is a standard for electronic data interchange between financial institutions in connection with real time transfers. When a transfer is a real time transfer, the funds are almost immediately available to the recipient of the transfer in the recipient's account. However, such immediate availability of funds, while desired, may be problematic for effective application of fraud detection and prevention schemes, as well as anti-money laundering (AML) schemes. The recipient may remove the funds from the account immediately following the transfer leaving little or no recourse to recover the funds if the transfer is determined to be fraudulent or to implicate AML schemes.

Uniquely, the systems and methods herein provide for messaging (e.g., in the form of network messages, electronic messages, internal messages, etc.), in connection with real time transfers, whereby a pseudo hold is placed on the transferred funds, or a part thereof, for an interval in order to permit use of (e.g., to provide time for application of, etc.) the fraud prevention and/or detection schemes. In particular, when a primary fund transfer between a user and a recipient includes one or more parameters that provide a suspicion of fraud or money laundering, etc., a platform identifies the one or more parameters (as a combination of and/or with machine learning models and human generated rules) and compiles and transmits a message, in real time, which initiates a subsequent transfer of funds from an account of the recipient, immediately following the primary fund transfer (for an amount of the transferred funds, or a part thereof). The message causes the funds to be moved from the recipient's account, which limits the recipient's access to the funds. After a time interval, the platform compiles and transmits a reversal message, in real time, which causes the funds moved from the recipient's account to be put back into the account. Alternatively, the message may not actually initiate a transfer (or removal) of the funds from the account of the recipient, but instead may initiate a hold on the funds (e.g., where the message includes a the pseudo authorization message, etc.). Then, once a human has approved the original transaction or after a predetermined time, the pseudo authorization will be reversed or aged off and/or the hold removed, whereby the funds are free for use in the account of the recipient. In this manner, in either case, the funds transferred from the user to the recipient may essentially be held, on a per transfer basis, in whole or in part, to permit sufficient time to ensure (or at least partially confirm) that the transfer is not fraudulent and not associated with money laundering.

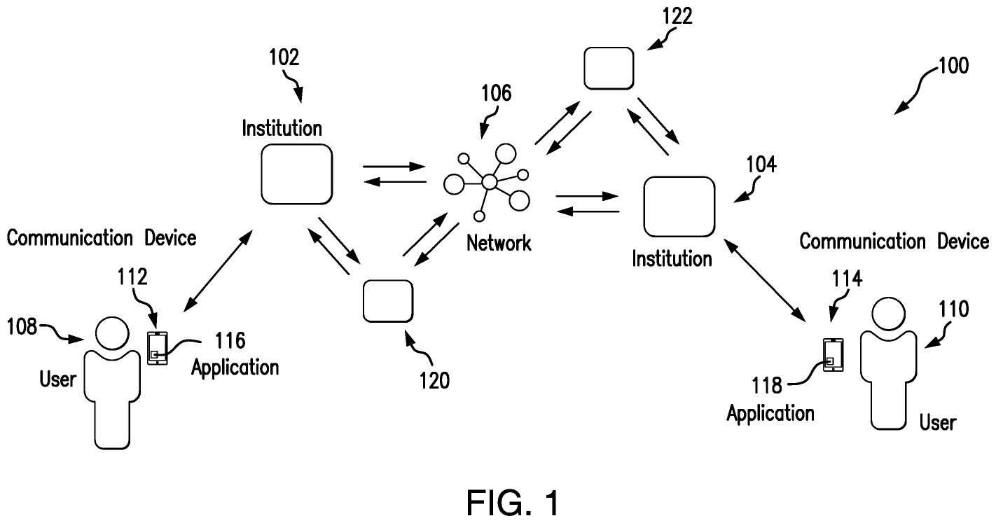

FIG. 1 illustrates an exemplary system 100, in which one or more aspects of the present disclosure may be implemented. Although the system 100 is presented in one arrangement in FIG. 1, other embodiments may include systems arranged otherwise depending, for example, on a manner in which messaging is initiated, specific standards employed in the networks, users involved in the messaging, privacy rules and regulations, etc.

In the illustrated embodiment, the system 100 generally includes institutions 102 and 104 and a real time payment network 106, each coupled to (and in communication with) one or more communication networks. The one or more communication networks are represented in FIG. 1 by the various arrowed lines and each may include, without limitation, a local area network (LAN), a wide area network (WAN) (e.g., the Internet, etc.), a mobile network, and/or another suitable public and/or private network capable of supporting communication among two or more of the parts illustrated in FIG. 1, or any combination thereof. For example, one of the networks may include multiple different networks, such as a private network made accessible by the network 106 to the institutions 102 and 104 and, separately, the public Internet, which is accessible as desired by the network 106 and/or the institutions 102 and 104 and one or more devices 112 and 114 associated with users 108 and 110 in the system 100, etc.

The institution 102 in the system 100 is a banking institution or financial institution, which is configured to issue one or more accounts (e.g., credit accounts, debit accounts, prepaid accounts, or other financial accounts or payment accounts, etc.) to users or other entities. In this example, the institution 102 is associated with user 108 and has issued an account to the user 108. Similarly, the institution 104 is a banking institution, which is configured to issue one or more accounts (e.g., credit accounts, debit accounts, prepaid accounts, or other financial accounts or payment accounts, etc.) to users or other entities. In this example, the institution 104 is associated with user 110 and has issued an account to the user 110. With that said, in various embodiments, the institutions 102 and 104 may each be other types of entities (e.g., financial or otherwise, etc.), while still associated with the users and/or fund transfers as described herein.

The institutions 102 and 104 are coupled in communication with the network 106. In this exemplary embodiment, the institutions 102 and 104 are configured to communicate with the network 106, via a real time transfer standard. In particular in this embodiment, the institutions 102 and 104 are configured to communicate with the network 106 via the ISO 20022 standard, thereby providing for real time (or near real time) transactions and/or fund transfers for accounts issued by the institutions 102 and 104. That is, the institutions 102 and 104 include computing resources dedicated to the ISO 20022 standard, whereby each is configured to participate in the origination and coordination of messaging in that standard (as related to fund transfers). In this manner, the network 106 may include any suitable real time payment platform, including, for example, The Clearing House or Zelle Network®, Mastercard Send, ACH, SEPA (European), or another national real time or faster pay network, etc. That said, it should be appreciated that the institutions 102 and 104 may be configured to communicate otherwise with the network 106, in other system embodiments, including, for example, via one or more application programming interfaces (APIs), etc., yet still provide (or support) real time transactions and/or fund transfers, as above.

As further shown in FIG. 1, the user 108 is associated with communication device 112, which includes a network-based application 116, and the user 110 is associated with communication device 114, which includes a network-based application 118. The communication devices 112 and 114 may include, without limitation, smartphones, tablets, personal computers, etc. And, the network-based applications 116 and 118 are generally consistent and may include, for example, a virtual wallet, an institution application (e.g., a banking application, etc.), or other application, which is associated with the users' accounts issued by the institutions 102 and 104 (e.g., as an account provisioned to the respective one applications 116 and 118, etc.). In this exemplary embodiment, the application 116 includes an application associated with the institution 102, which includes a software development kit (SDK) provided by the network 106. The SDK, as integrated in the application 116, permits the application 116 to configure the communication device 112 to operate as described herein (e.g., transmit fund transfer instructions, present transfer notices, etc.). Similarly, the application 118 includes an application associated with the institution 104, which includes a SDK provided by the network 106. The SDK, as integrated in the application 118, permits the application 118 to configure the communication device 114 to operate as described herein (e.g., transmit fund transfer instructions, present transfer notices, etc.).

In connection therewith, in response to at least one input from the user 108 to the application 116 to transfer funds to the user 110, the communication device 112 is configured, by the application 116, to provide a transfer instruction to the institution 102 and/or the network 106 directly, or via a third-party payment processor 120 (or, potentially, to call an API for transfer instructions exposed by the network 106, etc.), in order to initiate a real time transfer (or push) of funds from the account of the user 108 issued by the institution 102 to the account of the user 110 issued by the institution 104. In particular in this example, the communication device 112 is configured, by the application 116, to provide the transfer instruction to the payment processor 120, which is configured to validate the transaction with the institution 102 and then, upon approval, send it to the network 106. With that said, the transfer instruction may include, among other things, an amount of the transfer, an identification of the user's account at the institution 102, and an identification of the destination account at the institution 104 for the user 110, etc. In addition, the payment processor 120 may include a standalone entity (as illustrated in FIG. 1), or the payment processor 120 may include an entity incorporated with or otherwise associated with other parts of the system 100 such as, for example, the network 106, etc.

Alternatively in the system 100, the communication device 112 may instead be configured, by the application 116, to provide the transfer instruction directly to the institution 102. And, the institution 102 may be configured to then validate the transaction and, upon approval, engage the network 106 directly or through the payment processor 120 to facilitate the transfer. Or, as a further alternative, the communication device 112 may be configured, by the application 116, to provide the transfer instruction directly to the network 106, and the network 106, then, may be configured to authorize the transfer through the institution 102 (directly, or through the payment processor 120 associated with the institution 102). That said, it should be appreciated that use of the payment processor 120 is not required in all implementations of the system 100.

In turn, the network 106 is configured to receive the user's transfer instruction from the communication device 112 (via the application 116 or the API, for example), in one of the above-described manners. And, in response to the transfer instruction, the network 106 is configured to compile and transmit a fund transfer message to the institution 104, via a payment processor 122 associated therewith, where the fund transfer message is consistent with the ISO 20022 standard. The payment processor 122 may include a standalone entity (as illustrated in FIG. 1), or the payment processor 122 may include an entity incorporated with or otherwise associated with other parts of the system 100 such as, for example, the network 106, etc. For example, in one embodiment, the network 106 may include a platform, generally, and may also include the payment processor 120 and/or the payment processor 122 within the platform, that receives the transfer instruction from the communication device 112 (the payment processor 120) and that communicates the fund transfer message from the network 106 to the institution 104 (the payment processor 122). That said, in some embodiments, the system 100 may not utilize payment processors at all. In such embodiments, the network 106 and/or the institutions 102, 104 perform the required operations of the payment processor(s). When included, though, the processors 102, 122 may each include a subset of computing devices, separate from or within the platform of the network 106, and, for example, may be configured to “offer on-behalf-of” services to institutions, such as, for example, the institution 102 and/or the institution 104.

In response, the institution 102 is configured to debit the amount of the transaction from the account issued to the user 108, and to transfer the funds (i.e., as a primary fund transfer), immediately, to a settlement account of the network 106. Upon receipt of the funds, or other confirmation from the institution 102, the network 106 compiles and transmits a transfer message, consistent with the ISO 20022 standard, to the institution 104. The institution 104 then credits the amount of the transfer to the account issued to the user 110. The funds are latter settled between the institutions 102 and 106 and the network 106. The primary fund transfer is then complete.

Upon receiving the transfer instruction from the user 108 (e.g., based on the information included therein, based on historical data related to the accounts of either of the users 108 or 110, etc.), or in connection with transmitting the transfer instruction to the institution 104, the network 106 is configured to determine whether the fund transfer (and/or other transfers associated with the same account(s)) includes one or more parameters (e.g., transaction parameters, etc.) indicative of fraud. The parameters (e.g., transaction parameters, etc.) may include, without limitation, a particular sequence of and/or timing for transfers, frequencies of real time payments (made or received), certain merchant category codes associated with the transfers (e.g., where the recipient of the fund transfer is a merchant, etc.), certain transaction amounts (individually or cumulative), certain merchant locations (e.g., merchant countries, etc.), certain parties (e.g., identified money laundering entities, etc.) (e.g., name, country, email address, phone number, etc. of receiving entities and/or sending entities; etc.), risk scoring, seasonal norms (e.g., increased payments around holidays or tax dates, etc.), the financial entities involved with senders and/or recipients, geolocation data, authentication strength of the user 108 and/or the user 110 in connection with the transaction, etc. Additionally, the parameters may include a sequence of events outside the instant transfer, such as, for example, a check deposit to one of the accounts, etc. As an example, if the user 110 receives $100 in his/her account as a merchandise return credit from the network 106, and the user 110 then initiates an outbound $100 account-to-account real time payment a short time later (e.g., five minutes or less, ten minutes or less, etc.), the sequence of transactions may look like an attempt to monetize a compromised merchant terminal and thus may be identified by the network 106 as suspicions.

When one or more parameters of the transfer are determined to be indicative of fraud (based on a combination of machine learning models and human generated rules applying the one or more parameters), the network 106 is configured to compile and transmit a further transaction message (for a further, second transaction) for a hold transfer to the institution 104 (e.g., an ISO 20022 message, etc.), whereupon the institution 104 is configured to debit the amount of the primary fund transfer from the account issued to the user 110 and transfer the funds to the network 106 (i.e., the settlement account thereof) (as the second transaction). The hold transfer may be an amount up to the entire amount of the primary fund transfer, or it may be a portion of that amount. For example, the primary fund transfer may be $100, and the hold transfer may be $40 or 40% of the primary fund transfer. It should be appreciated that the amount may be indicated by the particular parameter or parameters that cause the hold transfer to be initiated. In connection with the hold transfer, the network 106 is configured to initiate and/or continue a fraud review for the primary fund transfer. Once completed (and if the transfer is identified as not fraudulent), or after a particular time interval, the network 106 is configured to compile and transmit a message to the institution 104 for a reverse transfer (e.g., as a further, third transaction; etc.), whereby the amount of funds associated with the hold transfer is debited from the network 106 and transferred back to the account of the user 110 at the institution 104.

Alternatively, when one or more parameters of the transfer are determined to be indicative of fraud, instead of actually debiting the amount of the primary fund transfer from the account of the user 110, the network 106 may compile and transmit the further transaction message to the institution 104 as a pseudo authorization message, whereupon the institution 104 may initiate a temporary hold on the funds (associated with the primary fund transfer) received in the account of the user 110. Here, the second transaction implicated by the pseudo authorization message (resulting in the temporary hold) is not actually completed; it instead results in the hold, for either the amount of the primary fund transfer or some portion thereof (e.g., the institution 104 may elect to only hold 50% of the funds associated with the primary fund transfer to limit the impact to the user 110, etc.). The hold leaves the funds in the user's account, but prevents the user 110 from spending or otherwise dispersing the held amount. As above, in connection with the hold, the network 106 and/or the institution 104 is configured to then initiate and/or continue a fraud review for the primary fund transfer. Once completed, if the primary fund transfer is identified as legitimate (or not fraudulent or not invoking anti-money laundering concerns), or if the pseudo authorization (i.e., for the second transaction) ages off without action by the institution 104, the second transaction will be cancelled (e.g., via a reversal, etc.) and/or the hold will be removed and the funds will be made available to the user 110. However, if the primary fund transfer is identified as fraudulent or as involving an anti-money laundering violation, the institution 104 may be configured to remove the funds from the user's account (e.g., via an appropriate mechanism such as balance adjustment, etc.) and the second transaction will be cancelled.

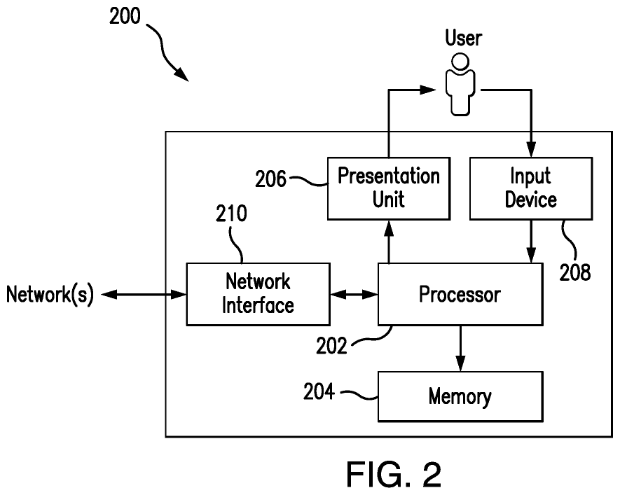

FIG. 2 illustrates an exemplary computing device 200 that can be used in the system 100. The computing device 200 may include, for example, one or more servers, workstations, personal computers, POS terminals, laptops, tablets, smartphones, PDAs, etc. In addition, the computing device 200 may include a single computing device, or it may include multiple computing devices located in close proximity or distributed over a geographic region as a network of computing devices, so long as the computing devices are specifically configured to function as described herein.

In particular, in the exemplary system 100 of FIG. 1, each of the institutions 102 and 104 and the network 106 should be understood as being implemented in (and/or otherwise including) one or more computing devices consistent with the computing device 200. In addition, the communication devices 112 and 114 may also (in at least one or more aspects) be consistent with computing device 200. That said, the system 100 should not be considered to be limited to the computing device 200, as described below, as different computing devices and/or arrangements of computing devices may be used in other embodiments. In addition, different components and/or arrangements of components may be used in other computing devices.

While the above is described in connection with messaging between the institutions 102 and 104, it should be appreciated that the present disclosure also applies to messaging within the institution 102 and/or within the institution 104. For example, the features of the present disclosure may be used in connection with a transfer of funds between accounts at the institution 102, etc.

Referring to FIG. 2, the exemplary computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, transaction data, parameters indicative of fraud, instructions for messaging in particular standards, and/or other types of data (and/or data structures) suitable for use as described herein.

Furthermore, in various embodiments, executable instructions may be stored in the memory 204 for execution by the processor 202 to cause the processor 202 to perform one or more of the operations described herein (e.g., one or more of the operations described in method 300, etc.), such that the memory 204 is a physical, tangible, and non-transitory computer readable storage media. Such instructions often improve the efficiencies and/or performance of the processor 202 that is performing one or more of the various operations herein, whereby the instructions effectively transform the computing device 200 into a special purpose device configured to perform the unique and specific operations described herein. It should be appreciated that the memory 204 may include a variety of different memories, each implemented in one or more of the functions or processes described herein.

In addition in the exemplary embodiment, the computing device 200 includes a presentation unit 206 that is coupled to (and is in communication with) the processor 202 (however, it should be appreciated that the computing device 200 could include output devices other than the presentation unit 206, etc.). The presentation unit 206 outputs information (e.g., a notification associated with a transfer, etc.), either visually or audibly, to a user of the computing device 200, for example, to the user 108 in the system 100, to users associated with other parts of the system 100, etc. And, various interfaces (e.g., as defined by applications, webpages, etc.) may be displayed at computing device 200, and in particular at presentation unit 206, to display such information. The presentation unit 206 may include, without limitation, a liquid crystal display (LCD), a light-emitting diode (LED) display, an organic LED (OLED) display, an “electronic ink” display, speakers, etc. In some embodiments, presentation unit 206 may include multiple devices.

The computing device 200 also includes an input device 208 that receives inputs from the user of the device (i.e., user inputs) such as, for example, transfer request instructions, etc. The input device 208 is coupled to (and is in communication with) the processor 202 and may include, for example, a keyboard, a pointing device, a mouse, a touch sensitive panel (e.g., a touch pad or a touch screen, etc.), another computing device, and/or an audio input device. Further, in various exemplary embodiments, a touch screen, such as that included in a tablet, a smartphone, or similar device (e.g., the mobile devices 112 and 114, etc.), may behave as both the presentation unit 206 and the input device 208.

In addition, the illustrated computing device 200 also includes a network interface 210 coupled to (and in communication with) the processor 202 and the memory 204. The network interface 210 may include, without limitation, a wired network adapter, a wireless network adapter, a mobile network adapter, or other device capable of communicating to/with one or more different networks, including one or more of the networks in FIG. 1. Further, in some exemplary embodiments, the computing device 200 may include the processor 202 and one or more network interfaces (including the network interface 210) incorporated into or with the processor 202.

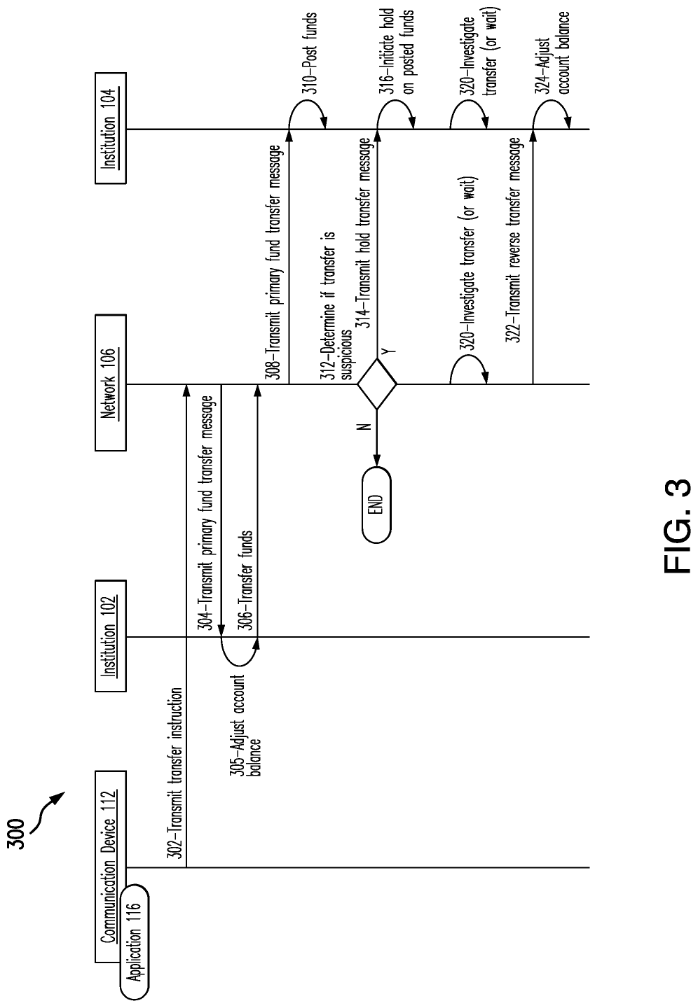

FIG. 3 illustrates an exemplary method 300 for use in facilitating a hold fund transfer from an account when a primary fund transfer is associated with one or more fraud parameters (suggesting that the primary fund transfer is fraudulent, etc.). The exemplary method 300 is described with reference to FIG. 1, and the institutions 102 and 104, the network 106, and the communication device 110 thereof, and also with reference to the computing device 200 of FIG. 2. However, it should be understood that the method 300 is not limited to the system 100 or the computing device 200. And, likewise, the systems and the computing devices herein should not be understood to be limited to the exemplary method 300.

At the outset in the method 300, the user 108 decides to transfer funds, in real time, from the user's account issued by the institution 102 to the account of the user 110 issued by the institution 104.

In connection with making the transfer, the user 108 accesses the application 116, at the communication device 112, and provides an instruction to transfer funds. The instruction includes an identifier of the source account of funds for the transfer, i.e., the account of the user 108, which may include an account number, a token, a phone number and/or email address, etc., associated with the account. The instruction also includes an identification of the destination account at the institution 104 (for the user 110), which may include, again, an account number, a token, a phone number and/or email address, etc., associated with the account. The instruction also includes an amount to be transferred, and any other details which may be needed or helpful in the transfer (e.g., a name of the sending user 108 (and/or other user identifier, mailing address, etc.), a name of the recipient user 110 (and/or other user identifier, phone number, mailing address, email address, etc.), a notation of a reason for the transfer, sanction screening data, etc.). It should be appreciated that, in various embodiments, the user 108 is authenticated, by the application 116 (and/or communication device 112), in connection with either accessing the application 116 or initiating the fund transfer. In such embodiments, single factor or multi-factor authentication may be used, based on a password, a PIN, a biometric, etc.

In response to the transfer instruction (from the user 108), in this example, the communication device 112, as configured by the application 116, transmits, at 302, a transfer instruction to the network 106 (e.g., directly or via the payment processor 120, etc.). The transfer instruction may be transmitted to the network 106 in any suitable manner, including, for example, as an electronic message (e.g., via a standard implementation between the institution 102 and the network 106 (e.g., consistent with the ISO 20022 standard, etc.), etc.) or as an API call to an API exposed by the network 106, etc.

Upon receipt of the transfer instruction, the network 106 compiles and transmits, at 304, a real time primary fund transfer message to the institution 102 (either directly or via the payment processor 120) for the primary fund transfer (i.e., for the transfer of the funds from the account of the user 108 to the account of the user 110) (consistent with the ISO 20022 standard). The message includes, similar to the above, at least an identification of the account of the user 108, an identification of the account of the user 110, and an amount to be transferred. Additional data may be included in the transfer message, as permitted and/or defined by the ISO 20022 standard to which the message conforms. Upon receipt of the message, the institution 102 validates the transaction and debits, at 305, the funds from the account of the user 108 (and adjusts the balance of the account accordingly) and transfers, at 306, the funds to the network 106, whereupon the funds are held in a settlement account of the network 106. In addition, the institution may also transmit an acknowledgement message to the communication device 112, notifying the user 108 of the transfer.

Upon receipt of the funds, the network 106 compiles and transmits, at 308, a primary fund transfer message to the institution 104 (e.g., directly or via the payment processor 122, etc.). In response, the institution 104 posts the transferred funds to the account of the user 110, at 310, and in some implementations adjusts the balance of the account of the user 110 to reflect the transfer. In connection therewith (e.g., concurrently with the sending the primary fund transfer message, prior to sending the primary fund transfer message, after sending the primary fund transfer message, etc.), the network 106 also determines, at 312, if the primary fund transfer is suspicious (e.g., as being fraudulent, as violating one or more anti-money laundering rules, etc.), based on the transfer conforming to and/or satisfying and/or including one or more parameters (in combination with machine learning models and/or human generated rules). Again, and as discussed above, example parameters indicative of fraud or money laundering, whereby investigation of the transfer is warranted, may include, without limitation, a particular sequence of and/or timing for transfers, frequencies of real time payments (made or received), certain merchant category codes associated with the transfers (e.g., where the recipient of the fund transfer is a merchant, etc.), certain transaction amounts (individually or cumulative), certain merchant locations (e.g., merchant countries, etc.), certain parties (e.g., identified money laundering entities, etc.) (e.g., name, country, email address, phone number, etc. of receiving entities and/or sending entities; etc.), risk scoring, seasonal norms (e.g., increased payments around holidays or tax dates, etc.), the financial entities involved with senders and/or recipients, geolocation data, authentication strength of the user 108 and/or the user 110 in connection with the transaction, etc. Additionally, the parameters may include a sequence of events outside the instant transfer, such as, for example, a check deposit to one of the accounts, etc.

When the primary fund transfer does not include a parameter indicative of a fraudulent transfer, the network 106 determines (at 312) that the primary fund transfer is not suspicious. The fund transfer is then allowed to proceed, and the method 300 ends.

In this exemplary embodiment, though, the network 106 determines that the primary fund transfer includes at least one parameter indicative of a fraudulent transfer, whereby the network 106 then determines (at 312) that the primary fund transfer is indeed suspicious. As such, the network 106 compiles and transmits, at 314, a pseudo authorization message to the institution 104 ((e.g., directly or via the payment processor 122, etc.) placing a hold on the transferred funds at the account of the user 110 (which is a real time message consistent with the ISO 20022 standard). It should be appreciated that the hold may be for the entire amount of funds identified in the primary fund transfer, or a percentage of the amount of the primary fund transfer, etc., or an amount above a threshold (e.g., $425 when the primary fund transfer is for $1425 (i.e., an amount of the transfer above $1000), etc.), etc. It should also be appreciated that different hold amounts or percentages or thresholds may be employed depending on the particular parameter prompting the hold fund transfer, etc. In any case, in response, the institution 104 initiates a temporary hold on the funds identified in the hold message and posted to the user's account (user 110), at 316. With that said, in some embodiments, the institution 104 may hold the funds when they arrive as a card-based account credit (e.g., as a merchandise return, etc.) to further prevent the funds from being rapidly spent via real time push payments.

Thereafter, at 320, the network 106 and/or the institution 104 investigates the transfer or, potentially, simply waits for a defined interval, such as, for example, 6 hours, 24 hours, 36 hours, 48 hours, one week, intervals there between, etc. After the defined interval, or when the network 106 and/or the institution 104 is sufficiently satisfied that the transfer is legitimate and/or accurate (e.g., is not fraudulent, does not violate anti-money laundering regulations, does not include false information, etc.) (e.g., based on the investigation, or potentially, a confirmation from the user 108; etc.), the network 106 (when the network 106 performs the investigation) compiles and transmits, at 322, a reversal message to the institution 104, which again is a real time message consistent with the ISO 20022 standard. Or, when the institution 104 performs the investigation, the institution 104 determines to reverse the hold. The reversal message from the network 106 and the reversal determination by the institution 104 generally removes the hold and/or cancels the transaction associated with the pseudo authorization message, whereby the funds in the use's account are made available to the user 110. As such, the institution 104, at 324, adjusts the balance of the user's account (user 110) to confirm the availability of the funds (if not already done). The funds, while credited to the account of the user 110, are settled among the institutions 102 and 104 and the network 106 at a later time.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) receiving, at a computing device (e.g., from a first institution, etc.), a first electronic message including an instruction associated with a first user and specific to a first user account (e.g., at the first institution, etc.), the instruction directed to a second user account of a second user; (b) transmitting, by the computing device, a second electronic message including the instruction (e.g., to a second institution associated with the second user account, etc.), whereby the second user account is adjusted (e.g., by the second institution, etc.) consistent with the instruction; (c) determining, by the computing device, whether the instruction satisfies one or more parameters; and (d) in response to the instruction satisfying the one or more parameters, compiling and transmitting, by the computing device (e.g., to the second institution, etc.), a third electronic message including a hold instruction, whereby the second user account is adjusted (e.g., by the second institution, etc.) to include a hold feature consistent with the hold instruction and whereby, in response to a confirmation regarding the hold instruction or in response to an expiration of a defined interval after transmitting the instruction, the second institution removes the hold feature from the second user account.

Exemplary embodiments are provided so that this disclosure will be thorough, and will fully ‘convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” and “at least one of” includes any and all combinations of one or more of the associated listed items.

In addition, as used herein, the term product may include a good and/or a service.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 110(f) unless an element is expressly recited using the phrase “means for,” or in the case of a method claim using the phrases “operation for” or “step for.”

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in facilitating messaging, the method comprising:
receiving, at a computing device, a first electronic message including an instruction associated with a first user and specific to a first user account, the instruction directed to a second user account of a second user;
transmitting, by the computing device, to an entity associated with the second user account, a second electronic message including the instruction, whereby the second user account is adjusted consistent with the instruction;
determining, by the computing device, whether the instruction satisfies one or more parameters; and
after transmitting the second electronic message and in response to the instruction satisfying the one or more parameters, compiling and transmitting, by the computing device, to the entity associated with the second user account, a third electronic message including a hold instruction, whereby the second user account is adjusted to include a hold feature consistent with the hold instruction and whereby, in response to a confirmation regarding the hold instruction or in response to an expiration of a defined interval after transmitting the instruction, the hold feature is removed from the second user account.

2. The computer-implemented method of claim 1, further comprising compiling and transmitting, by the computing device, a reversal instruction including the confirmation regarding the hold instruction, the confirmation instructing removal of the hold feature from the second user account.

3. The computer-implemented method of claim 2, further comprising investigating a content of the instruction in response to the instruction satisfying the one or more parameters; and
wherein compiling and transmitting the reversal instruction includes compiling and transmitting the reversal instruction in response to a determination by the investigation that the content of the instruction is accurate.

4. The computer-implemented method of claim 1, wherein the computing device is included in a payment network.

5. The computer-implemented method of claim 4, wherein receiving the first electronic message including the instruction associated with the first user and specific to the first user account includes receiving said first electronic message from a first institution, via a computing device of a payment processor associated with the first institution.

6. The computer-implemented method of claim 5, wherein the entity associated with the second user account is a second institution, wherein the instruction included in the first electronic message includes a real-time instruction for a fund transfer from the first user account at the first institution to the second user account at the second institution.

7. The computer-implemented method of claim 6, wherein transmitting the second electronic message including the instruction includes transmitting the second electronic message to the second institution in real time.

8. The computer-implemented method of claim 6, further comprising receiving, by the computing device, from the first institution, funds for the fund transfer.

9. The computer-implemented method of claim 8, wherein transmitting the second electronic message to the second institution includes transferring the funds to the second institution, whereby the second institution posts the funds to the second user account.

10. A system for use in facilitating electronic messages, the system comprising a computing device configured to:
receive, from a first institution, a first electronic message including an instruction to transfer funds from an account of a first user at the first institution to an account of a second user;
receive the funds from the first institution;
transmit the funds to a second institution associated with the account of the second user, whereby the second institution posts the funds to the account of the second user;
determine that the instruction to transfer the funds includes one or more predefined transaction parameters indicative of fraud; and
transmit, to the second institution, a second electronic message including a hold instruction, whereby the second institution initiates a temporary hold on the funds posted to the account of the second user.

11. The system of claim 10, further comprising a payment network, and
wherein the computing device is included in the payment network.

12. The system of claim 11, wherein the computing device is configured, in order to receive the first electronic message, to receive the first electronic message from a payment processor associated with the first institution consistent with an ISO 20022 standard.

13. The system of claim 12, wherein the instruction included in the first electronic message is a real-time instruction for a fund transfer from the account of the first user to the account of the second user.

14. The system of claim 12, wherein the computing device is configured to transmit the funds to the second institution in real time.

15. The system of claim 14, wherein the computing device is further configured to compile and transmit a reversal instruction to the second institution including a confirmation regarding the hold instruction, the confirmation instructing the second institution to remove the temporary hold on the funds posted to the account of the second user.

16. A non-transitory computer-readable storage medium including executable instructions for facilitating network messages, which when executed by at least one processor of a payment network, cause the at least one processor to:
receive, from a first institution, a first network message including an instruction associated with a first user and specific to a first user account at the first institution, the instruction directed to a second user account of a second user;
transmit a second network message including the instruction to a second institution associated with the second user account, whereby the second institution adjusts the second user account consistent with the instruction;
determine whether the instruction satisfies one or more parameters; and
after transmitting the second network message and in response to the instruction satisfying the one or more parameters, compile and transmit, to the second institution, a third network message including a hold instruction, whereby the second institution adjusts the second user account to include a hold feature consistent with the hold instruction and whereby, in response to a confirmation regarding the hold instruction or in response to an expiration of a defined interval after transmitting the instruction, the second institution removes the hold feature from the second user account.

17. The non-transitory computer-readable storage medium of claim 16, wherein the executable instructions, when executed by the at least one processor, further cause the at least one processor to compile and transmit a reversal instruction to the second institution including the confirmation regarding the hold instruction, the confirmation instructing removal of the hold feature from the second user account.

18. The non-transitory computer-readable storage medium of claim 16, wherein the executable instructions, when executed by the at least one processor in connection with receiving the first network message, further cause the at least one processor to receive the first network message from a computing device of a payment processor associated with the first institution.

19. The non-transitory computer-readable storage medium of claim 18, wherein the instruction included in the first network message includes a real-time instruction for a fund transfer from the first user account at the first institution to the second user account at the second institution; and
wherein the executable instructions, when executed by the at least one processor in connection with transmitting the second network message, cause the at least one processor to transmit the second network message to the second institution in real time.

20. The non-transitory computer-readable storage medium of claim 19, wherein the executable instructions, when executed by the at least one processor in connection with transmitting the second network message to the second institution, cause the at least one processor to transfer the funds to the second institution, whereby the second institution posts the funds to the second user account.
